(19) United States
(12) Patent Application Publication
(10) Pub. No.: US 2009/0155682 A1
(43) Pub. Date: Jun. 18, 2009

(54) STRUCTURE OF A BATTERY SET

(75) Inventors: Chao-Feng LEE, Hukou Township (TW); Hsiang-Wen Yao, Hukou Township (TW); Shu-Chen Ho, Hukou Township (TW)

Correspondence Address: Muncy, Geissler, Olds & Lowe, PLLC, P.O. BOX 1364, FAIRFAX, VA, 22038-1364, US

(73) Assignee: SIMPLO TECHNOLOGY CO., LTD.

(21) Appl. No.: 12/098,607

(22) Filed: Apr. 7, 2008

(30) Foreign Application Priority Data
Dec. 17, 2007 (TW) 96221477

(51) Int. Cl. H01M 2/02

(52) U.S. Cl. 429/163

(57) ABSTRACT

This invention is to disclose a structure of a battery set comprising a case, a battery body, a holder and a filling body. The case is formed like a clamp shape having an open space inside. The battery body disposed in the open space has a PCB adjacent to an open end of the holder. The holder is disposed on the open end thereof for holding the PCB. The filling body consists of one portion thereof filled in the open space to secure the battery body, and the remaining portions thereof respectively extending outwards to cover the outer side of the case. Therefore, the filling body both secures the holder and the protecting case and seals the open space.

### RELATED APPLICATIONS

This application claims priority to Taiwan Application Serial Number 96221477, filed Dec. 17, 2007, which is herein incorporated by reference.

### BACKGROUND

1. Field of Invention

This invention is related to a battery set, and more particularly to the structure of a battery set being fastened with a filling body inserted by injection molding.

2. Description of Related Art

Downsizing battery sizes for these devices has become a critical task with the increased use for portable communication products. Battery packs for these devices must be securely packed in a decent, downsized package. If the package of the battery set is not securely and firmly sealed, short circuits or chemical substance spillage may occur to damage the battery cell or the circuit board of the battery set after.

A conventional method for packing a battery set is to couple a plastic case to a lower case with injection molding technology, to secure a battery cell at a predetermined position in the lower case, and to enclose the lower case with an upper case with glue to completely enfold the battery cell, and to use an outer package to cover both the lower case and upper case.

However, Solidifying by using glue between the upper and lower case takes a lot of time, there may be tons of semi-finished products during mass production process, which would postpone the follow-up packing processes. Also, if the glue applied between the upper and lower case is not quite even, part of the upper case may rise and come off the lower case to weaken the structural intensity of the battery set. In conclusion, the above structure of the battery set package must be improved.

### SUMMARY

It is therefore an objective of the present invention to disclose a structure of a battery set in order to enhance of the battery set.

To achieve the foregoing objectives, the present invention provides a structure of a battery set including a case, a battery body, a holder and a filling body. The case is formed like a clamp shape with an open space inside. The battery body is disposed in the open space, and has a circuit board adjacent to one open end of the case. The holder is coupled with an open end of the case and fastens the circuit board. The filling body has a portion fully provided in the open space to hold the battery body securely, and the remaining portions extending outwards from the open space to cover the outer surfaces of the case. Thus, the filling body secures the holder and the case together, and also seals the open space.

To sum up, the filling body of the present invention is filled from the inside of the case towards the outside to further seal around its edges. Therefore, the present invention provides advantages such as securing the battery body in the case to prevent the battery body from being removed and tightly coupling the case with the holder to protect the structure of the battery set, and can downsize the size of the battery set and save time in the production of battery set.

### BRIEF DESCRIPTION OF THE DRAWINGS

The structure and the technical means adopted by the present invention to achieve the above and other objects can be best understood by referring to the following detailed description of the preferred embodiments and the accompanying drawings, where:

FIG. 1 is an exploded view of a battery set according to the present invention;

FIG. 2 is a perspective view of the battery set after Insert Injection Molding according to the present invention;

FIG. 3 is a A-A′ sectional view of the battery set after Insert Injection Molding according to the FIG. 2;

FIG. 4 is a flow chart according to a manufacturing process of the battery set of the present invention;

FIG. 5 is a schematic view of the case according to another embodiment of the present invention.

### DESCRIPTION OF THE PREFERRED EMBODIMENTS

It is to be understood that the following disclosure provides one or more preferred embodiment, or examples, for implementing different features of the disclosure. Specific examples of components and arrangements are described below to simplify the present disclosure. These are, of course, merely examples and are not intended to be limited. In addition, the present disclosure may repeat reference numerals and/or letters in the various examples. This repetition is for the purpose of simplicity and clarity and does not in itself dictate a relationship between the various embodiments and/or configurations discussed.

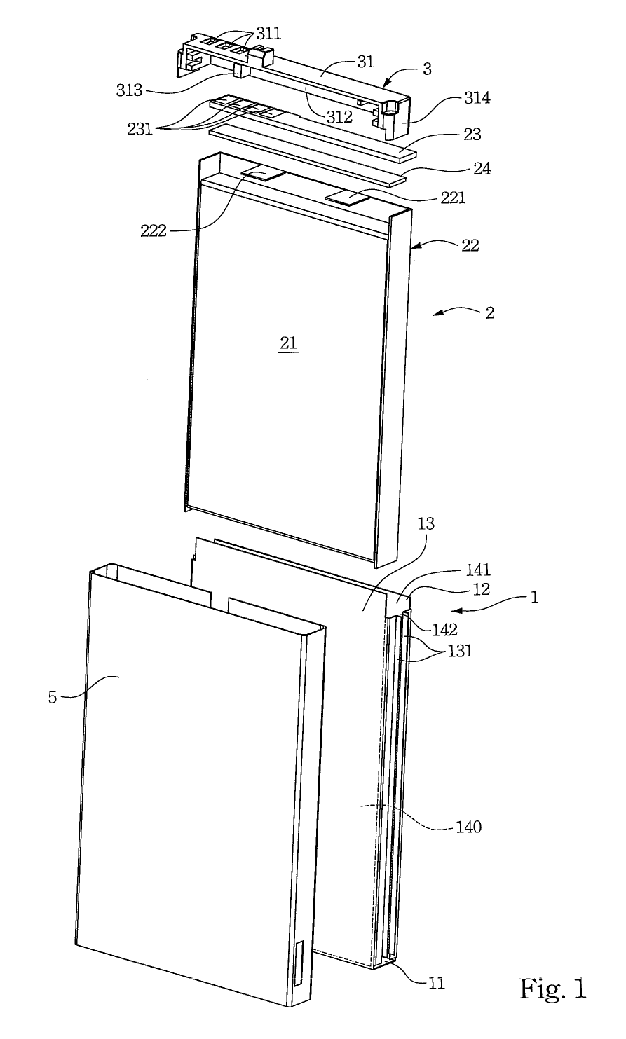

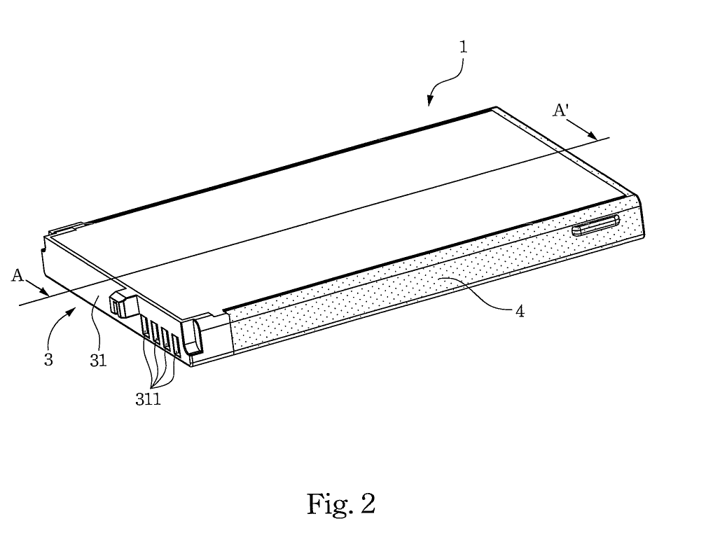

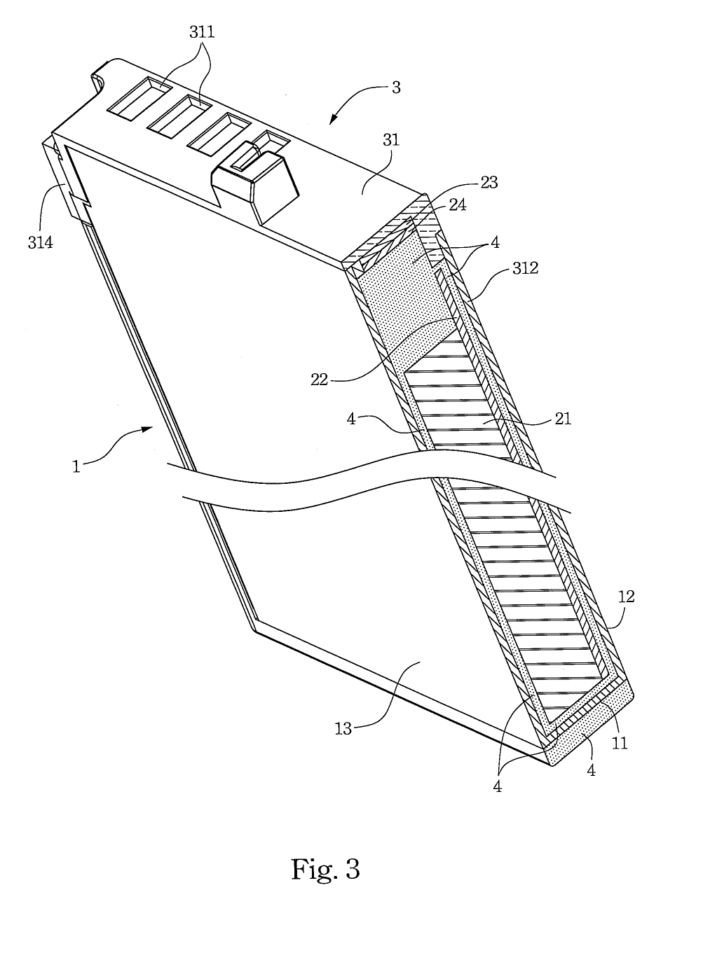

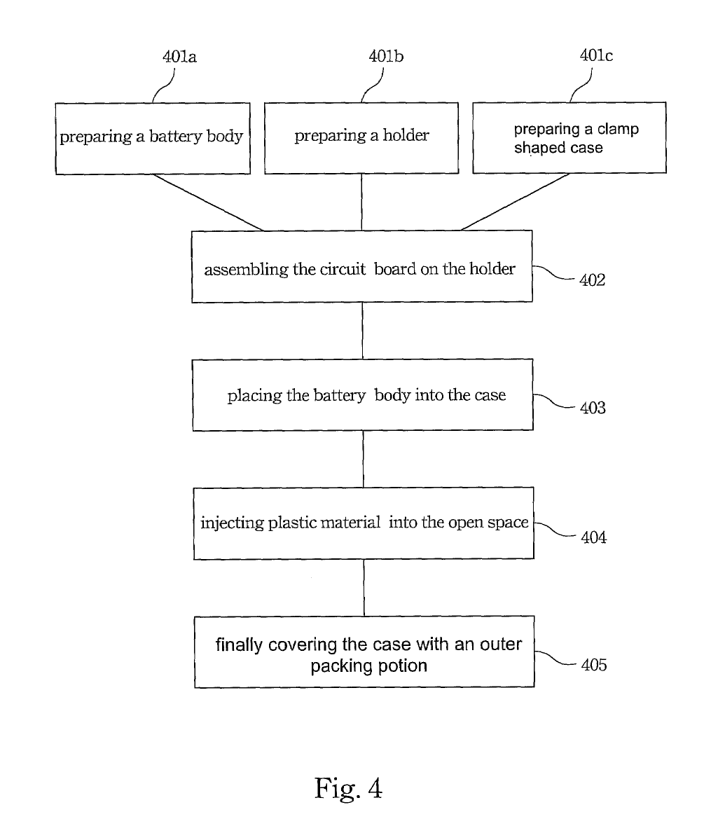

Please refer to FIG. 1, FIG. 2 and FIG. 3 simultaneously. FIG. 1 is an exploded view of a battery set according to the present invention. FIG. 2 is a perspective view of the battery set after Insert Injection Molding according to the present invention. FIG. 3 is an A-A′ sectional view of FIG. 2. The present invention provides a structure of a battery set at least having a case 1, a battery body 2, a holder 3 and a filling body 4, which is usually adopted on a portable electronic device, such as a camcorder, a mobile phone, a personal digital assistant (PDA) and the like. FIG. 4 is a flow chart according to a manufacturing process of the battery set of the present invention. The steps of assembling the battery set and descriptions of those elements are discussed as following:

Step (401a) Preparing a Battery Body 2:

In this step a battery body 2 is prepared. The battery body 2 includes a battery cell 21, an electrode plate 22 and a circuit board 23. The circuit board 23 has a plurality of conductive pads 231 disposed on a side of the battery cell 21. The conductive pads 231 are arranged on a side of the circuit board 23 against the battery cell 21, and are provided to transmit electric current outwards from the battery cell 21.

The electrode plate 22, e.g. Ni-plate, which is disposed on another side of the battery cell 21 has a first electrode 221 and a second electrode 222, in which the first electrode 221 is electronically connected to a positive electrode of the battery cell 21 and the circuit board 23, and the second electrode 222 is electronically connected to a negative electrode of the battery cell 21 and the circuit board 23. Thus, the positive electrode and the negative electrode of the battery cell 21 cooperatively output electric current to the circuit board 23 via the contacts with the first and second electrode 221 and 222. Accordingly, the circuit board 23 then transmits the output of the electric current outwards. To prevent from the occurrence of a short circuit, an isolating plate 24 is placed between the circuit board 23 and the electrode plate 22 in the case.

Step (401b) Preparing a Holder 3:

Essentially, the holder 3 is a plastic piece 31 made by the plastic material inserted through the injection molding procedure, wherein the plastic piece 31 has several opening holes 311, a flange 312 and two connecting flanges 314 in which each of the opening holes 311 corresponds to and fits one of the conductive pads 231 of the circuit board 23, the flange 312 extends towards the battery body 21 from an edge of the plastic piece 31 and has at least a rib 313 thereon for holding the circuit board 23 on the flange 312, and these connecting flanges 314 extend respectively from two opposite ends of the plastic piece 31 as the way the flange 312 extends.

Step (401c) Preparing a Case 1 Formed Like a Clamp Shape;

The case 1 is made by a metal piece of Integrated Forming Manufacture (e.g. pressing technology). The case 1 includes a first section 11, a second section 12 and a third section 13, wherein the size of the first section 11 is smaller than either the second section 12 or the third section 13, and the second section 12 and the third section 13 are respectively disposed on two opposite sides of the first section 11 and extend in a same direction as the second section 12 and the third section 13 facing to each other

Obviously, the case 1 is formed like a clamp shape, in which an open space 140 is defined among the first section 11, the second section 12 and the third section 13, a first opening 141 is defined between an end of the second section 12 and an end of the third section 13, wherein both ends thereof are far away from the first section 11, and two second openings 142 are defined respectively between a first edge of the second section 12 and a first edge of the third section 13, and between a second edge of the second section 12 and a second edge of the third section 13, wherein the first edge of the second section 12 is opposite to the second edge of the second section 12, and the first edge of the third section 13 is opposite to the second edge of the third section 12 and the second openings 142 are interconnected to the first opening 141 and the open space 140.

It is understood that the next step can be carried out as long as the case 1, holder 3 and battery body 2 are prepared. The steps (401a), (401b) and (401c) do not need to be done in order.

Step (402) Assembling the Circuit Board 23 on the Holder 3;

With this step, by holding the circuit board 23 on the flange 312 by the rib 313, the circuit board 23 is assembled on the holder 3 and its conductive pads 231 are respectively orientated towards one of the opening holes 311 to expose the holder 3.

Step (403) Placing the Battery Body 2 into the Case 1;

After the battery body 2 which has been equipped with the holder 3 is put into the open space 140 of the case 1, and a side of the holder 3 that has exposed the conductive pads 231 is shown on a side of the case 1, a semi-finished product waiting for injection molding is temporarily called.

In this semi-finished product, the holder 3 is disposed on the first opening 141 between the second section 12 and the third section 13, so that the holder 3 supports the second section 12 and the third section 13, and keeps the distance of the openings 141 and 142 between the second section 12 and the third section 13 equidistant. Therefore, the holder 3 can be a support between the second section 12 and the third section 13 to prevent damage to the battery body 2 from pressing the second section 12 and the third section 13 towards the open space 140.

On the other hand, the holder 3 is placed in the first opening 141 and the opposite second openings 142 interconnect to the open space 140. Also, each connecting flange 314 of the plastic plate 31 extends from two ends of the holder 3 and is connected over the seconds opening 142 by the remaining portion of the filling body 4.

Step (404) Injecting Plastic Material into the Open Space 140:

In this step, the semi-finished product is placed into a mold and plastic material is injected into the open space 140 via one of the second openings 142. After some of the plastic material completely fills the open space 140, the remaining plastic material flows outwards through both second openings 142, wherein the remaining plastic material divided into two directions after the remaining plastic material flows out of the case 1, one direction of the remaining plastic material respectively flows from both second openings 142 towards the holder 3 and finally reaches the connecting flanges 314.

Another direction of the remaining plastic material respectively flows from both second openings 142 towards the first section 11 and meets together on the surface of the first section 11 against the open space 140 (i.e. the outer surface of the first section 11). Thus, after the plastic material in the mold is cooled and forms the filling body 4, a portion of the filling body 4 completely fills the open space 140 to hold the battery body 2. The remaining portions of the filling body 4 cover the second openings 142 from one connecting flange 314 to the other connecting flange 314 via the outer surface of the first section 11. Therefore, the filling body 4 firmly secures the case 1, holder 3 and the battery body 2 together.

Step (405) Finally Covering the Case 1 with an Outer Packing Potion 5;

The last step is to cover the case 1 covered with the filling body 4 with an outer packing potion 5 that could be a plastic covering (e.g. film or cover) or a paster (e.g. paper for pasting), so that the outer packing potion 5 protects the filling body 4 from damage. In addition, the outer packing potion 5 also provides testing data and manufacturing information thereon.

To sum up, the filling body 4 of the present invention is made of filling plastic material. The plastic material fills the case 1 from the inside of the case 1 towards the outside and seals the edges of the case 1. Therefore, the present invention provides advantages such as securing the battery body 2 in the case 1 from being removed, tightly securing the case 1 and the holder 3, protecting the structure of the battery set, downsizing the size of the battery set, and saving time in production of battery set.

In order to secure the case 1 over the second openings 142 with the remaining portions of the filling body 4, the opposite edges of the second section 12 or the third section 13 respectively further extend at least a holding flange 131 towards the third section 13 or second section 12. These holding flanges 131 could have an “L” shaped or a “Z” shaped profile, thus these holding flanges 131 provide much more surfaces of the third section 13 or second section 12 for the remain portion of the filling body 4 to stick on the case 1, thus, the filling body 4 will not be easily separated from the case 1.

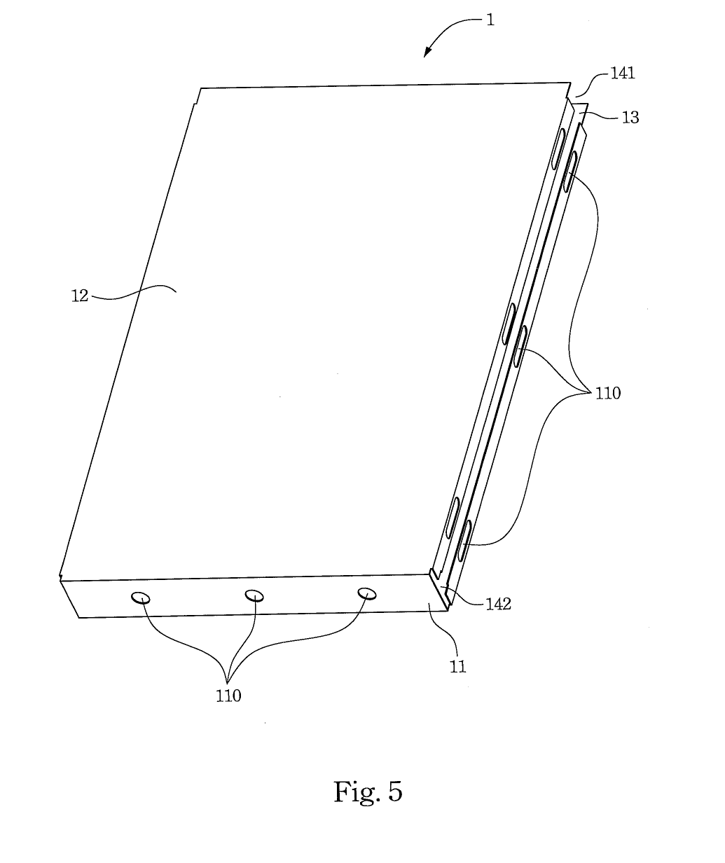

FIG. 5 is a schematic view of the case 1 according to another embodiment of the present invention. To prevent the remaining portion of the filling body 4 on the outer surface of the first section 11 from being separated easily, a plurality of apertures 110 is formed on the first section 11. Some plastic material mentioned in the step (404) will go through the apertures 110 and flow to the surface of the first section 11 against the open space 140. Thus, after the plastic material is cooled, the remaining portion of the filling body 4 is extending outwards via the apertures 110. Hence, the filling body 4 provides a stronger adhesive for the case 1 through the apertures 110. The apertures 110 can be formed on either the holding flanges 131 of the second section 12 or the holding flanges 131 of the third section 13 and receive the part of the filling body 4 from the open space 140 outwards to the other parts of the filling body 4.

Although the present invention has been described in considerable detail with reference in the certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without parting from the scope or spirit of the invention.

Such as the followings can be modified in mode:

1. changing the material of the case 1 into metal, alloy or plastic;

2. changing the shape of the holder 3 into a “U” shape or a rectangle shape, wherein the rectangle shaped holder 3 with one side of the holder 3 blocks the first opening 141 and the rest sides thereof will be grabbed by the filling body 1.

In view of the foregoing, it is intended that the present invention cover modifications and variations of this invention provided they fall within the scope of the following claims and their equivalents.

What is claimed is:

1. A structure of a battery set, comprising:
a case having an open space therein;
a battery body disposed in the open space, and having a circuit board adjacent to an open end of the case;
a holder coupled with the open end of the case and fastening the circuit board; and
a filling body having a portion thereof fully provided in the open space to hold the battery body, and remaining portions thereof extending outwards from the open space to cover the outer surfaces of the case to secure the holder and the case together.

2. The structure of the battery set as claimed in claim 1, wherein the case has a clamp shaped profile, comprising:
a first section;
a second section disposed on one side of the first section and extending in a direction that one surface of the first section faces; and
a third section disposed on another side of the first section against the second section, and extending towards the direction that the second section extends.

3. The structure of the battery set as claimed in claim 2, wherein a plurality of apertures is formed on the first section and the remaining portions of the filling body extend outwards via the apertures.

4. The structure of the battery set as claimed in claim 2, wherein the remaining portions of the filling body respectively cover an opening between a first edge of the second section and a first edge of the third section, another opening between a second edge of the second section opposite to the first edge of the second section and a second edge of the third section opposite to the first edge of the third section, and a surface of the first section against the open space.

5. The structure of the battery set as claimed in claim 4, wherein the holder is disposed between the second section and the third section that are far away from the first section, and the holder keeps a distance of the gaps between the second section and the third section equidistant.

6. The structure of the battery set as claimed in claim 5, wherein two connecting flanges are respectively extended from two ends of the holder and are respectively connected over the openings by the remaining portion of the filling body.

7. The structure of the battery set as claimed in claim 4, wherein at least one holding flange is extended from the edge of the second section towards the third section and provides the remaining portions of the filling body to stick.

8. The structure of the battery set as claimed in claim 7, wherein each of the holding flanges has an “L” shape or a “Z” shape profile.

9. The structure of the battery set as claimed in claim 7, wherein a plurality of apertures is formed on each of the holding flanges and the remaining portions of the filling body extend outwards via the apertures.

10. The structure of the battery set as claimed in claim 4, wherein at least one holding flange is extended from the edge of the third section towards the second section and provides the remaining portions of the filling body to stick.

11. The structure of the battery set as claimed in claim 10, wherein each of the holding flanges has an “L” shape or a “Z” shape profile.

12. The structure of the battery set as claimed in claim 10, wherein a plurality of apertures is formed on each of the holding flanges and the remaining portions of the filling body extend outwards via the apertures.

13. The structure of the battery set as claimed in claim 1 further comprises an outer packing potion covering surfaces of the case.

14. The structure of the battery set as claimed in claim 13, wherein the outer packing potion is a plastic covering or a paster.

15. The structure of the battery set as claimed in claim 1, wherein the case is made of metal, alloy or plastic.
